(19) United States
(12) Patent Application Publication
(10) Pub. No.: US 2009/0260029 A1
(43) Pub. Date: Oct. 15, 2009

(54) Multi-media target marketing (formerly viewer controlled television target marketing)

(76) Inventor: Christopher Adrien Roosen, Peachtree City, GA (US)

Correspondence Address: Christopher A. Roosen, 614 Grecken Green, Peachtree City, GA, 30269, US

(21) Appl. No.: 12/284,885

(22) Filed: Sep. 26, 2008

Related U.S. Application Data
(60) Provisional application No. 60/979,277, filed on Oct. 11, 2007.

(51) Int. Cl. H04N 7/16

(52) U.S. Cl. 725/25

(57) ABSTRACT

A computer (software and/or hardware) controlled electronic device, either freestanding or device controlled, that allows a television viewer, internet user or cellular phone user to choose what kind of commercial or advertising content to allow into their home or onto their device.

Presently, only one commercial can be aired, and one time slot sold per commercial slot, but the Multi-Media Target Marketing invention allows Viewer's to choose the commercial content coming into their home, and gives the Networks' the ability to sell multiple-commercials -in the same market and the same time slot. This will allow for more revue by selling more airtimes, as well as saving the Advertiser money by pinpointing their Target Market and focusing on it.

The five (5) televisions represent the ability of the invention to reach consumers, while giving the Consumer the choice in what commercial content they view, but is not limited solely to television.

### Multi-Media Target Marketing (Formerly Viewer Controlled Television Target Marketing)

### REFERENCE TO DRAWINGS

FIG. 1 Represents Network Programming. Programming is centralized at the network and broadcast via digital means.

FIG. 2 Represents The Network Server. Presently, the Server sends out the Programming nationwide without regard to -demographics. The Multi-Media Target Marketing invention allows those watching the same television programming to receive User Specific commercials, which is sent to the User's television based upon User specified demographics.

FIG. 3 Represents Adult Content Commercial.

FIG. 4 Represents Adult Content Commercial.

FIG. 5 Represents. Family Content Commercial.

FIG. 6 Represents General Content Commercial.

FIG. 7 Represents General-Content Commercial.

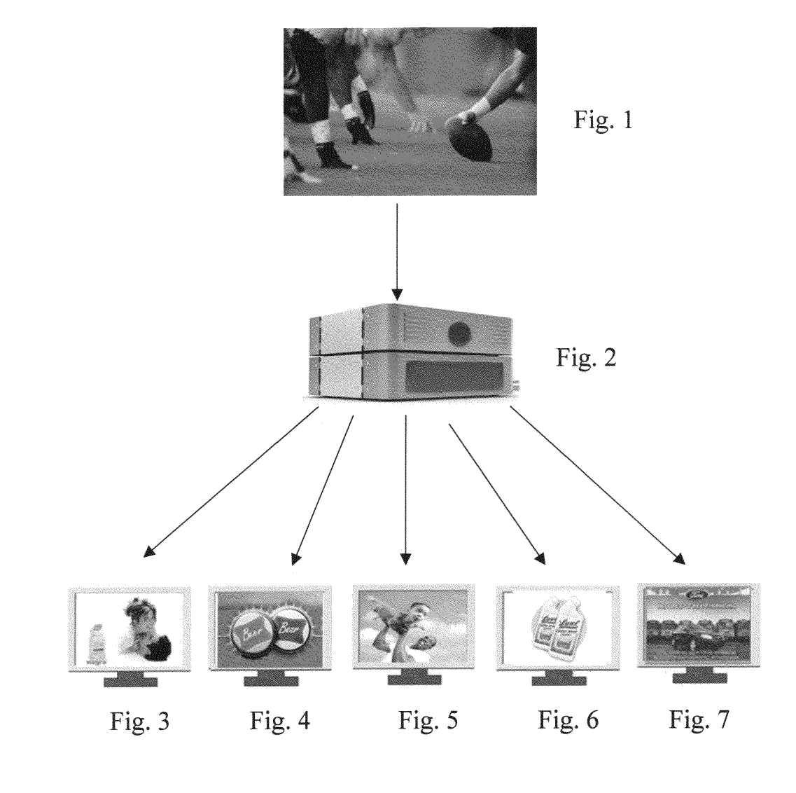

### DESCRIPTION

The present invention relates to multi-media target marketing. The invention is compromised of the following components:
(1) Software program(s) are used to code data into commercials based on a set of parameters specifying which category a commercial will fall into. For example; family friendly, children, openly sexual alcoholic beverages, adult (ie. Viagra), etc.
(2) Viewer Controlled Storage Device, or Control Box. A computer chip, hard drive or similar device which will allow the storage of Content Parameters for the commercial category and details what is or is no acceptable commercial viewing for the consumer. The storage device is to limited to a data chip, but could also include a hard drive on a cable/satellite box and/or television set and/or a computer hard drive or handheld device (such as a cell phone or ipod type device)
(3) Software program(s) (along the lines of an Internet cookie) which analyze the digitally coded data in commercials, and of the parameters that are stored on the Viewer Controlled Storage Device. These programs will be able to read the data on the Storage Device, allowing communication between the network server and the viewer's device or control box.
(4) A static, viewer specific address, known as a Viewer Specific (VS) Address which identifies the household, user or device (similar to an IP Address). This allows the computer programs to pinpoint the specific identity of the User.
(5) Computer Server(s). These act as a loading area for commercial content based upon the different types of commercial viewing categories.
(6) Remote Control, which allows the user to easily program Content Parameters.
(7) Additional Identities which can be unlocked by Master Control, allowing the authorized user to override Content Parameters for specific times of use.
   In a nutshell, a code is written into the every commercial that is broadcast, and will specify which category that commercial belongs in. The Viewer uses a simple pull down menu to specify what type of commercial programming they will permit into their home. An adult only household may choose adult or mature content, then that the option to choose specific items in which they're open to, while a household with children will choose family friendly, as well as specific items them may be interested in.

Using a remote control and software that has programmed an easy to use pull-down menu (or suitable alternative), the Viewer programs the data chip/hard drive as to what type of commercial content will be allowed into the home or viewing device. Once the parameters are set and stored, the software program on a Network and/or Satellite Server reads the stored data parameters and Viewer Specific (VS) Identification Address from the viewer and determines the Content Parameters. When a commercial break comes, Main Satellite Server will choose the appropriate commercial content, which is encoded with data meeting the Content Parameter requirements, and will then send appropriate commercial content to the viewers VS Address. They will then send the commercial content to the VS Address, allowing for the advertiser and the network/internet provider/webpage the ability to send multiple messages within the specific time frame(r) where before they may have been able to send one. During that 30 second time period the advertiser is reaching their target market, the viewer is receiving requested content and the networks are able to increase their bottom line with the ability to sell the same 30 second spot multiple times. This can also work on hardwire Cable Network services using their coaxle cables.

An example would be the digital code for Family Friendly Commercials with a subheading blocking fast food. Instead of seeing a commercial for a fast food franchise, the viewer and his family would see an alternate commercial to their specification Content Parameters, such as a commercial for organic food or fruit juice. During that same 30 second time period, another viewer could consent to Adult or Mature content, while another chooses another category altogether. The amount of Target Market's is limited only to the creation of Marketing Segments.

People will no longer be offended by commercial products sent to them that they don't wish to see, while allowing the advertiser to market their products to a specific demographic rather than scattershot, as well as opening up the possibility that Consumers will actually watch the commercials as apposed to skipping past them using a DRV or other similar device. The advertiser will also know where their advertising dollars are being spent, and the outlet (television, Satellite Radio, Cellular phone, etc.) is able to sell time slots several times over.

The invention also opens up a whole new way in which to sell blocks or advertising. It is viewer specific based upon standard marketing breakdowns (18-35 male demographics, etc.) as well as viewer specific criteria.

Based upon the idea of ever changing technology, more cost effective ways of constructing the device may be available.

This invention could also be used with Satellite Radio services, as well as the Internet, handheld computer devices, cellular phones as well as electronic devices to come. Eventually, the device and concept could also open up new methods of program transmission, where ultimately the viewer could choose the date, time and type of programming they would like to watch or at their convenience. Also, with regards to regional advertising superimposed upon the screen for certain events, they could also be controlled by the data code written into the commercial segment.

What is claimed is:

1. A computer (software and/or hardware) utilizes a Static Internet Protocal (IP) type of Address, which will be called a Viewer Specific (VP) Address (formerly Consumer Control Address (CC) that identifies the household or viewing device. Software programs and servers are used to send and receive data stored on a computer chip or hard drive (much like an Internet cookie), which makes sure the appropriate content material is transmitted to that VS Address. All content is coded with a rating that allows the viewer or subscriber to choose what kind of advertising or commercial content into their home or device, thereby becoming a unique section of the Target Market, which allows Advertisers, Advertising outlets and rating services to better understand their audience and to direct their advertising dollars toward a specific target market or audience.
